(19) United States
(12) Patent Application Publication
(10) Pub. No.: US 2021/0198980 A1
(43) Pub. Date: Jul. 1, 2021

(54) METHOD AND SYSTEM FOR GENERATING VIRTUAL REALITY IMAGES OF A DRILLING RIG SITE

(71) Applicant: Schlumberger Technology Corporation, Sugar Land, TX (US)

(72) Inventors: James Arthur Zapico, Houston, TX (US); Juan-Carlos Yepez, Katy, TX (US); Paul Andrew Thow, Spring, TX (US)

(21) Appl. No.: 16/727,985

(22) Filed: Dec. 27, 2019

(51) Int. Cl. E21B 41/00; G06T 19/00

(52) U.S. Cl. CPC E21B 41/0092; G06T 19/006

(57) ABSTRACT

A method may include obtaining a request for a virtual reality (VR) image of a first VR area among a plurality of VR areas proximate a drilling rig. The first VR area may be associated with at least one drilling rig device. The method may include obtaining, a captured image from a camera device disposed in the first VR area. The method may include determining a VR user perspective based on motion tracking data of a VR user device. The method may include generating, using the captured image, a VR image from the VR user perspective. The method may be performed by a VR manager.

### BACKGROUND

Drilling rig sites include multiple hazardous locations that require management and supervision from an operator. The operator may be a person located in an management room, such as a driller's cabin in which a clear perspective of view of a drilling hole is required for performing various tasks for the proper operation of the drilling rig site. Specifically, the operator may be required to work in one of these hazardous environments for several hours. As the operator remains in the hazardous location, the probability of danger to the well-being of the operator increases. As such, to ensure the safety of the operator at all times, drilling rig sites implement several layers of protection. Specifically, a drilling rig site may be implemented with hardware and software to safeguard the well-being of the operator. As such, drilling rig sites are expensive to build and difficult to maintain because an operator is required to interact directly with every area inside the drilling rig site.

### SUMMARY

In general, in one aspect, embodiments relate to a method that includes obtaining, by a virtual reality (VR) manager, a request for a VR image of a VR area among a plurality of VR areas proximate a drilling rig. The VR area is associated with at least one drilling rig device. The method includes obtaining, by the VR manager, a captured image from a camera device disposed in the VR area. The method includes determining, by the VR manager, a VR user perspective based on motion tracking data of a VR user device. The method includes generating, by the VR manager and using the captured image, a VR image from the VR user perspective.

In general, in one aspect, embodiments relate to a system that includes a drilling rig device and a camera device disposed in a VR area near a drilling rig. The system includes a VR user device disposed outside the VR area. The system includes a VR manager comprising a processor and coupled to the VR user device and the camera device over a drilling management network. The system includes a VR manager that obtains a captured image from the camera device and generates a VR image using a portion of the captured image and a VR user perspective based on motion tracking data of the VR user device.

In general, in one aspect, embodiments relate to a non-transitory computer readable medium storing instructions executable by a computer processor. The instructions include functionality for obtaining, by a VR manager, a request for a VR image of a VR area among a plurality of VR areas proximate a drilling rig. The VR area is associated with a drilling rig device. The instructions include functionality for obtaining, by the VR manager, a captured image from a camera device disposed in the VR area. The instructions include functionality for determining, by the VR manager, a VR user perspective based on motion tracking data of a VR user device. The instructions include functionality for generating, by the VR manager and using the captured image, a VR image from the VR user perspective.

Other aspects of the disclosure will be apparent from the following description and the appended claims.

### BRIEF DESCRIPTION OF DRAWINGS

FIG. 1 shows a block diagram of a system in accordance with one or more embodiments.

FIG. 2 shows a block diagram of a system in accordance with one or more embodiments.

FIG. 3 shows a block diagram of a system in accordance with one or more embodiments.

FIG. 4 shows a flowchart in accordance with one or more embodiments.

FIG. 5 shows a flowchart in accordance with one or more embodiments.

FIG. 6 shows an example in accordance with one or more embodiments.

FIG. 7 shows an example in accordance with one or more embodiments.

FIGS. 8A and 8B show a computing system in accordance with one or more embodiments of the invention.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include methods and systems directed to providing one or more virtual reality (VR) images of a hazardous location in a drilling rig site. In particular, on a drilling rig, rather than carving out a space for a driller to sit at drill floor level, the driller may be located at some nominal distance away from the rig while interacting with drilling equipment. Specifically, assuming that latency times in electronic communications may be considered negligible, the driller may be able to see an entire of the drill floor level through several images captured by camera devices. As such, the driller may able to access various camera device locations using a VR user device. Furthermore, the driller may be virtually transported into locations around a drilling rig that would normally be considered unsafe or difficult to place a human operator.

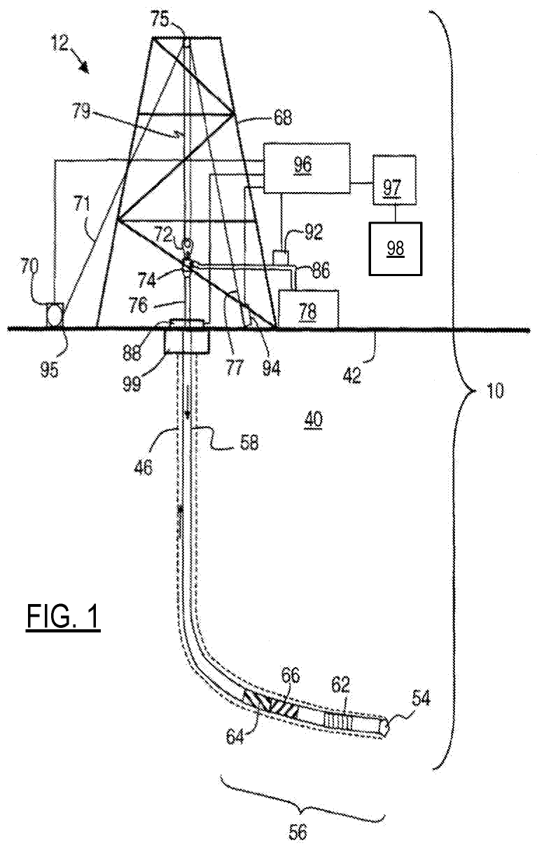

FIG. 1 shows a block diagram of a system in accordance with one or more embodiments. FIG. 1 shows a drilling system (10) according to one or more embodiments having various equipment that are supervised, and controlled, during a drilling operation by one or more camera devices (98) described herein. Drill string (58) is shown within borehole (46). Borehole (46) may be located in the earth (40) having a surface (42). Borehole (46) is shown being cut by the action of drill bit (54). Drill bit (54) may be disposed at the far end of the bottom hole assembly (56) that is attached to and forms the lower portion of drill string (58). Bottom hole assembly (56) may include a number of devices including various subassemblies. Measurement-while-drilling (MWD) subassemblies may be included in subassemblies (62). Examples of MWD measurements may include direction, inclination, survey data, downhole pressure (inside the drill pipe, and/or outside and/or annular pressure), resistivity, density, and porosity. Subassemblies (62) may also include a subassembly for measuring torque and weight on the drill bit (54). The signals from the subassemblies (62) may be processed in a processor (66). After processing, the information from processor (66) may be communicated to pulser assembly (64). Pulser assembly (64) may convert the information from the processor (66) into pressure pulses in the drilling fluid. The pressure pulses may be generated in a particular pattern which represents the data from the subassemblies (62). The pressure pulses may travel upwards though the drilling fluid in the central opening in the drill string and towards the surface system. The subassemblies in the bottom hole assembly (56) may further include a turbine or motor for providing power for rotating and steering drill bit (54).

The drilling rig (12) may include a derrick (68) and hoisting system, a rotating system, and/or a mud circulation system, for example. The hoisting system may suspend the drill string (58) and may include draw works (70), fast line (71), crown block (75), drilling line (79), traveling block and hook (72), swivel (74), and/or deadline (77). The rotating system may include a kelly (76), a rotary table (88), and/or engines (not shown). The rotating system may impart a rotational force on the drill string (58). Likewise, the embodiments shown in FIG. 1 may be applicable to top drive drilling arrangements as well. Although the drilling system (10) is shown being on land, those of skill in the art will recognize that the described embodiments are equally applicable to marine environments as well.

The mud circulation system may pump drilling fluid down an opening in the drill string. The drilling fluid may be called mud, which may be a mixture of water and/or diesel fuel, special clays, and/or other chemicals. The mud may be stored in mud pit (78). The mud may be drawn into mud pumps (not shown), which may pump the mud though stand pipe (86) and into the kelly (76) through swivel (74), which may include a rotating seal. Likewise, the described technologies may also be applicable to underbalanced drilling If underbalanced drilling is used, at some point prior to entering the drill string, gas may be introduced into the mud using an injection system (not shown).

The mud may pass through drill string (58) and through drill bit (54). As the teeth of the drill bit (54) grind and gouge the earth formation into cuttings, the mud may be ejected out of openings or nozzles in the drill bit (54). These jets of mud may lift the cuttings off the bottom of the hole and away from the drill bit (54), and up towards the surface in the annular space between drill string (58) and the wall of borehole (46).

At the surface, the mud and cuttings may leave the well through a side outlet in blowout preventer (99) and through mud return line (not shown). Blowout preventer (99) comprises a pressure control device and a rotary seal. The mud return line may feed the mud into one or more separator (not shown) which may separate the mud from the cuttings. From the separator, the mud may be returned to mud pit (78) for storage and re-use.

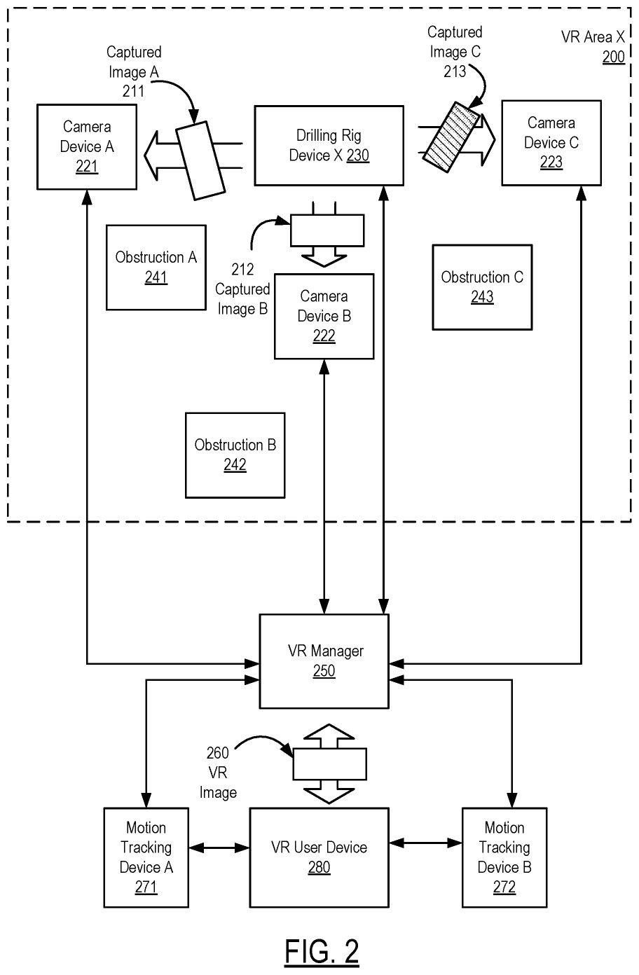

Various sensors may be placed on the drilling rig (12) to take measurements of the drilling equipment. In particular, a hookload may be measured by hookload sensor (94) mounted on deadline (77), block position and the related block velocity may be measured by a block sensor (95) which may be part of the draw works (70). Surface torque may be measured by a sensor on the rotary table (88). Standpipe pressure may be measured by pressure sensor (92), located on standpipe (86). Signals from these measurements may be communicated to a surface processor (96) or other network elements (not shown) disposed around the drilling rig (12). In addition, mud pulses traveling up the drillstring may be detected by pressure sensor (92). For example, pressure sensor (92) may include a transducer that converts the mud pressure into electronic signals. The pressure sensor (92) may be connected to surface processor (96) that converts the signal from the pressure signal into digital form, stores and demodulates the digital signal into useable MWD data. According to various embodiments described above, surface processor (96) may be programmed to automatically detect one or more rig states based on the various input channels described. Processor (96) may be programmed, for example, to carry out an automated event detection as described above. Processor (96) may transmit a particular rig state and/or event detection information to user interface system (97) which may be designed to warn various drilling personnel of events occurring on the rig and/or suggest activity to the drilling personnel to avoid specific events. The one or more camera devices (98) may capture one or more images of one or more areas in the drilling system (10). The one or more camera devices (98) may communicate directly with the processor (96) and/or the user interface system (97) as well as one or more mechanical components that utilize electrical power to operate. The one or more camera devices (98) will be described in more detail in FIG. 2.

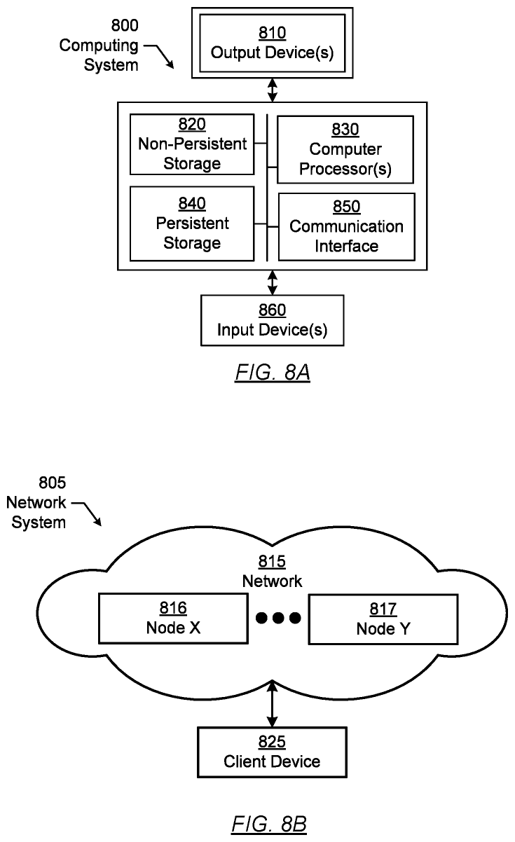

Turning to FIG. 2, FIG. 2 shows a block diagram of a system in accordance with one or more embodiments. As shown in FIG. 2, an area inside the rig site may be a hazardous area (e.g., VR area X (200)) including various camera devices (e.g., camera device A (221), camera device B (222), and camera device C (223)) configured to capture and transfer of various captured images (e.g., captured image A (211), captured image B (212), and captured image C (213)) of the drilling rig site (e.g., drilling rig device X (230)). The various camera devices may be positioned to avoid obstruction of a field of view of the drilling rig device by various obstruction elements (e.g., obstruction A (241), obstruction B (242), and obstruction C (243)) in the VR area. The VR area may include communications with a VR manager (250) located outside of the VR area. The VR manager (250) may communicate with various motion tracking devices (e.g., motion tracking device A (271) and motion tracking device B (272)) for tracking a VR user device (e.g. VR user device (280)) and for transferring at least one VR image (e.g., VR image 260). The VR manager (250) may receive and transmit signals as shown by the lines with arrows. In particular, the VR manager may be hardware and software including the functionality of viewing the VR area. The VR manager may include one or more electronic components coupled to one or more additional systems. These components and their functionality will be explained in more detail in reference to FIGS. 8A and 8B.

Further, the VR area may be a structure including hardware with functionality to enclose operational elements to be captured in VR. The VR area may include hazardous conditions or hazardous elements capable of providing harm to one or more people working in communication with the VR area. The VR area may include a combination of one or more levels, or floors, in such a way to incorporate one or more different locations in a drilling rig. The VR area may be incorporated partially or entirely in the drilling rig. The VR area may include one or more structures including hardware with functionality for communicating with various elements outside of the VR area. These various elements may include one or more transmitters, or receivers, capable of withstanding various environmental conditions.

The captured images (e.g., captured image A (211), captured image B (212), and captured image C (213)) maybe physical or digital representations of one or more perspectives in the VR area. For example, the captured images may be perspective representations from every cardinal point in the VR area. In some embodiments, the captured images may be a combination of different perspective images that show all of the VR area when combined.

In one or more embodiments, the camera devices (e.g., camera device A (221), camera device B (222), and camera device C (223)) are hardware or software configured for obtaining the various captured images. As such, the camera devices may be positioned inside or outside a VR area to obtain images of the inside of the VR area. In some embodiments, the camera devices may be focused perspective of a specific element inside the VR area. As such, the VR area may be delimited by the area of coverage provided by the images captured by the camera devices. In some embodiments, the camera devices may include hardware or software for moving attached to one or more mechanical and electrical components. As such, the camera devices may include tripod extensions capable of displacement on flat surfaces, stairs, or rough terrain. In some embodiments, the camera devices may be assembled along a robotic arm or in combination with hardware or software capable of receiving instructions from the VR manager (250) and implementing the received instructions by interacting with elements inside the VR area.

In one or more embodiments, a drilling rig device (230) may be drilling equipment such as hardware and software capable of performing or affecting operations in a rig site. As such, for example, the drilling rig device (230) may be heavy machinery, a panel or switchboard, or drilling equipment that interacts with one or more of the camera capturing devices positioned in in the VR area. The drilling rig device (230) may be hardware previously configured for containing a human user in a hazardous location that has been retrofitted to allow interaction and operation by one or more capturing devices. As such, the drilling rig device (230) may be a permanent or an occasional fixture in a rig site. For example, the drilling rig device (230) may be a drilling cabin in a hazardous location assisting in the drilling of a well, or the drilling rig device (230) may be a generator set providing power to the rig site and disposed in a non-hazardous location.

In one or more embodiments, the obstruction elements (e.g., obstruction A (241), obstruction B (242), and obstruction C (243)) are any hardware or terrain that prevents the camera device from obtaining a captured image of a specific area of the VR area. As such, the obstructions may be deformations on the terrain partially, or completely, in between a camera device and the VR area, the drilling rig device (230), or a combination of the two. In some embodiments, the obstructions are fixed features or movable features inside the VR area. As such, an obstruction may be moved by a camera device to place the obstruction out of the line of sight between the camera device and a point of interest in the VR area.

In addition, each captured image may be associated to a specific camera device that may be positioned to overcome the blocking caused by a specific obstruction. As such, a captured image A (211) may be obtained by a dedicated camera device A (221) positioned to avoid blocking caused by an obstruction A (241). In some embodiments, there are more camera devices than obstruction elements. In one or more embodiments, the camera devices obtain different types of captured images. These types may be heat tracing images, electromagnetic spectrum images, infrared images, or images based only on the visual spectrum.

The VR manager (250) may be hardware and software with functionality of transmitting and receiving signals to electronic devices. As such, the VR manager may exchange image data information and commands with the camera devices, the drilling rig device (230), or both. In some embodiments, the VR manager may control the movement, operations, and power of the camera devices and the drilling rig device (230). In addition, the VR manager (250) may determine the perspective angles and views of the captured images by placing the camera devices in a given capturing position. As such, the VR manager may determine the definition of an obstruction element and a point of interest inside the VR area. In one or more embodiments, the VR manager affects operations inside the VR area as if a human user were inside the VR area by using robotic features or remote control features of the camera devices and the drilling rig device (230). In addition, the VR manager (250) may include hardware or software including the functionality of collecting one or more raw images captured by the camera devices to create a VR image (260).

In one or more embodiments, the VR image (260) may include a VR space (not shown) which allows a user device to interact in scalable dimensions with surrounding areas. In some embodiments, the VR image may be a combination of one or more captured images from inside the VR area or the VR image may be a combination of simulated points of interest inside the VR area and one or more of the captured images. As such, in an event were visibility is difficult inside the VR area (e.g., at night or during harsh weather conditions), gyroscopic data and location information of the camera devices with respect to a point of interest may provide a location for a synthetic image in the VR space in the VR image. In one or more embodiments, the VR image may include awareness image data including color coding based on heat patterns inside the VR area.

In one or more embodiments, motion tracking devices (e.g., motion tracking device A (271) and motion tracking device B (272)) may be positioned in a location with a perspective centered on the VR user device. The motion tracking devices may be hardware or software with functionality for monitoring a VR user device's position, e.g., in order to determine a VR image using a VR manager. The motion tracking devices may be optical systems or non-optical systems. Optical systems may be hardware and software configured for tracking passive markers, active markers, or identified movable elements without markers (markerless). Non-optical systems may track based upon electromagnetic, mechanical, or inertial components. In one or more embodiments, the motion tracking devices follow a specific type of motion or a trigger from the VR user device (280). As such, the motion tracking devices may be hardware or software places around the VR user device (280). The motion tracking devices may include gyroscopes, long and short range scanning sensors, or accelerometers for collecting surrounding data.

In one or more embodiments, a VR user device (280) is hardware or software capable of accessing a perspective view of the VR image. The VR user device (280) may be a VR headset, monitoring screens, and overlay software configured for communicating with the VR manager. In some embodiments, the VR user device (280) may include VR controls (not shown) capable of scaling to actions performed by the camera devices. In one or more embodiments, the VR manager in collaboration with location information from the motion tracking devices, may monitor a location of the VR user device (280) and the location of the VR controls for translating of commands to be performed by the camera devices. As such, the VR controls may input a command for pressing a button in the drilling rig device (230) within the VR space inside the VR image that the VR manager would immediately translate into actually pushing the button on the drilling rig device (230) inside the VR area.

Further, user devices (e.g., VR user device (280)) may include hardware and/or software for receiving inputs from a user and/or providing outputs to a user. Moreover, a user device may be coupled to a drilling management network and/or a cloud server. For example, user devices may include functionality for presenting data and/or receiving inputs from a user regarding various drilling operations and/or maintenance operations performed within a drilling management network. Examples of user devices may include personal computers, smartphones, human machine interfaces, and any other devices coupled to a network that obtain inputs from one or more users, e.g., by providing a graphical user interface (GUI). Likewise, a user device may present data and/or receive control commands from a user for operating a drilling rig. In one or more embodiments, the VR manager may be coupled to a human machine interface of one or more control systems in the drilling management network. For example, an input from a VR user device may be transmitted to the VR manager. Accordingly, the VR manager may communicate the input to a respective human machine interface, which may subsequently translate the input into a command for a respective control system.

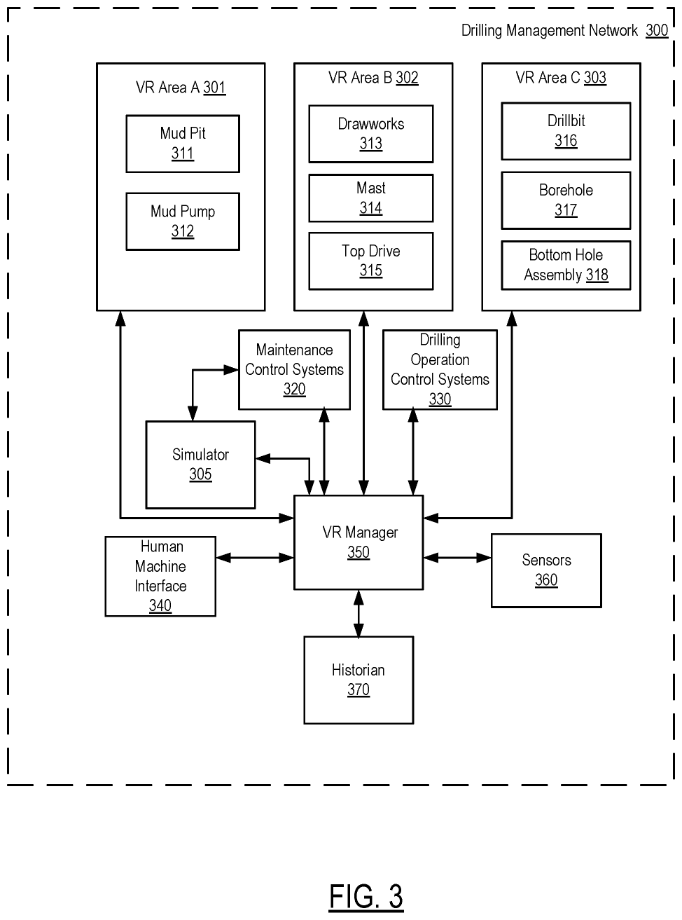

Turning to FIG. 3, FIG. 3 shows a block diagram of a system in accordance with one or more embodiments. As shown in FIG. 3, a drilling management network (300) may include various VR areas (e.g., VR area A (301), VR area B (302), and VR area C (303)), one or more maintenance control systems (e.g., maintenance control system (320)), one or more drilling operation control systems (e.g., drilling operation control system 330), a human machine interface (HMI) (e.g., human machine interface (340)), one or more sensors (e.g. sensors (360)), one or more record keeping systems (e.g., historian (370)), and at least one VR manager (e.g., VR manager (350)). In one or more embodiments, a drilling management network (300) may include drilling equipment described with respect to FIG. 1 and the accompanying description.

A drilling management network may further include various drilling operation control systems (e.g., drilling operation control systems (330)) and various maintenance control systems (e.g., maintenance control systems (320)). Drilling operation control systems and/or maintenance control systems may include, for example, various electronic devices that include hardware and/or software with functionality to control one or more processes performed by a drilling rig, including, but not limited to the components described in FIG. 1. As such, these electronic devices may be programmable logic controllers (PLCs), microcontrollers, programmable interface controllers (PICs), or programmable logic devices (PLDs). Specifically, an electronic device may control valve states, fluid levels, pipe pressures, warning alarms, and/or pressure releases throughout a drilling rig. In particular, a programmable logic controller may be a ruggedized computer system with functionality to withstand vibrations, extreme temperatures, wet conditions, and/or dusty conditions, for example, around a drilling rig. Without loss of generality, the term “control system” may refer to a drilling operation control system that is used to operate and control the equipment, a drilling data acquisition and monitoring system that is used to acquire drilling process and equipment data and to monitor the operation of the drilling process, or a drilling interpretation software system that is used to analyze and understand drilling events and progress.

In one or more embodiments, a sensor device includes functionality to establish a network connection (not shown) with one or more devices and/or systems (not shown), drilling operation control systems (330), and maintenance control systems (320) on a drilling management network. In one or more embodiments, for example, the network connection may be an Ethernet connection that establishes an Internet Protocol (IP) address for the sensors (360). Accordingly, one or more devices and/or systems on the drilling management network (300) may transmit data packets to the sensors (360) and/or receive data packets from the sensors (360) using the Ethernet network protocol. For example, sensor data may be sent over the drilling management network (300) in data packets using a communication protocol. Sensor data may include sensor measurements, processed sensor data based on one or more underlying sensor measurements or parameters, metadata regarding a sensor device such as timestamps and sensor device identification information, content attributes, sensor configuration information such as offset, conversion factors, etc.

A HMI may be hardware and/or software coupled to the drilling management network (300). For example, the HMI may allow the operator to interact with the drilling system, e.g., to send a command to operate an equipment, or to view sensor information from drilling equipment. The HMI may include functionality for presenting data and/or receiving inputs from a user regarding various drilling operations and/or maintenance operations. For example, a HMI may include software to provide a graphical user interface (GUI) for presenting data and/or receiving control commands for operating a drilling rig.

A network element may refer to various hardware components within a network, such as switches, routers, hubs or any other logical entities for uniting one or more physical devices on the network. In particular, a network element, the human machine interface, and/or the historian may be a computing system similar to the computing system (800) described in FIGS. 8A and 8B, and the accompanying description.

In one or more embodiments, various sensor devices (e.g., sensors (360)) are coupled to the drilling management network (300). In particular, a sensor device may include hardware and/or software that includes functionality to obtain one or more sensor measurements, e.g., a sensor measurement of an environment condition proximate the sensor device. The sensor device may process the sensor measurements into various types of sensor data. For example, the sensors (360) may include functionality to convert sensor measurements obtained from sensor circuitry (not shown) into a communication protocol format that may be transmitted over the drilling management network (300) by a communication interface. Sensor devices may include pressure sensors, torque sensors, rotary switches, weight sensors, position sensors, microswitches, etc. The sensor devices may include smart sensors. In some embodiments, sensor devices include sensor circuitry without a communication interface or memory. For example, a sensor device may be coupled with a computer device that transmits sensor data over the drilling management network (300).

In one or more embodiments, the drilling management network (300) includes the VR manager (350) coupled to one or more of the various elements previously described with respect to FIG. 3. As such, the VR manager (350) may have immediate access to data collected, evaluated, or communicated through any of the other elements described with respect to FIG. 3. In addition, the VR manager (350) may maintain communication with one or more of the VR areas in the manner discussed between VR manager and VR area in FIG. 2. In some embodiments, the drilling management network (300) is described as having various VR sites, where each VR site is a combination of at least one VR area coupled with a hardware or software performing the functions of a VR manger as described in FIGS. 2 and 3. Further, the VR manager (350) may be communicating with one or more VR areas simultaneously as to enable multiplexing of information transmitted from the various areas upon request. As such, the VR manager (350) may receive information from one, or all, VR area(s) at the same time.

Similarly, peripherals and other elements coupled to the VR manager (350) may transmit data and commands through the VR manager (350) to the camera devices. As such, VR areas may be operated, or affected, by commands transmitted from the VR manager (350) in real time with no noticeable latency. In addition, the commands transmitted by the VR manager (350) may be emergency safety responses triggered by sampling performed by one or more components coupled to the VR manager (350) described therein. For example, a command may be transmitted to any, or all, camera devices upon detecting a specific input from the human machine interface (340) or by detecting a hazardous condition by combining samplings of the sensors (360) and historical data pulled from the historian (370).

In some embodiments, the VR manager is used to perform remote drilling For example, a VR manager may be located remotely from a drilling rig. In such scenarios, a remote connection may be established between a VR manager and a drilling management network. For example, the remote connection may be established using a 5G connection, such as a protocols established in Release 15 and subsequent releases of the 3GPP/New Radio (NR) standards. Moreover, the VR manager may provide a virtual reality control cabin offsite from a drilling rig. For example, the VR control cabin may provide a user with an experience of being onsite at the drilling rig and proximate controls and human machine interfaces that operate systems on the drilling rig. Moreover, a VR control cabin may also be produced onsite at a drilling rig, e.g., multiple VR control cabins may be produced around a drilling rig in addition to the actual control cabin. Moreover, a VR manager may also be used in connection with a green room in which the VR manager may simulate one or more VR areas by filtering out the green portions in the room and interposing the VR area. For example, the VR manager may provide an augmented reality experience for an actual control cabin and/or other rooms in a drilling rig.

In one or more embodiments, a VR user device may obtain images regarding more than one VR area. For example, the VR user may receive instructions to obtain VR images of a different location in the drilling management network (300) as the VR user shifts from location to location as needed. Examples of possible locations may include: on the racking board, next to a well center during a well control event; and on the mud pits, in front of an ideally placed structure which would otherwise have to be moved to allow for safe line of sight.

In one or more embodiments, the drilling management network (300) includes a simulator (i.e., simulator (305)) coupled to a VR manager. In particular, the simulator may include hardware and/or software with functionality to generate models based on outputs obtained from a remote rig and through a VR user device. For example, a simulator may provide simulations of different equipment locations or equipment sizes within a particular area on a drilling rig. As such, the location or the size of the at least one drilling device may be adjusted in response to a simulation. In one or more embodiments, the simulator may be coupled to various control systems in a drilling management network and the VR manager (350) such that areas of a drilling rig may be wholly or partially simulated by the simulator (305). Specifically, the simulator may obtain drilling equipment data regarding a particular control system in order to generate a simulation of a VR area, control system, or a drilling rig device, which may then be translated into a VR image by the VR manager. In some embodiments, a simulator and a VR manager may be used for control system design, training, and testing. Further, the simulator may maintain a repository of various models for different VR areas, control systems, etc. As such, the simulator may be used to adjust drilling operations and/or maintenance operations by control systems at a drilling rig.

In one or more embodiments, the simulator (305) may be configured for using augmented reality (AR) markers. As such, the simulator (305) and the VR manager (350) may be located in the VR cabin for the VR area to be recreated in a green room environment with the added benefit of AR applications.

While FIGS. 1, 2, and 3 show various configurations of components, other configurations may be used without departing from the scope of the disclosure. For example, various components in FIGS. 1, 2, and 3 may be combined to create a single component. As another example, the functionality performed by a single component may be performed by two or more components.

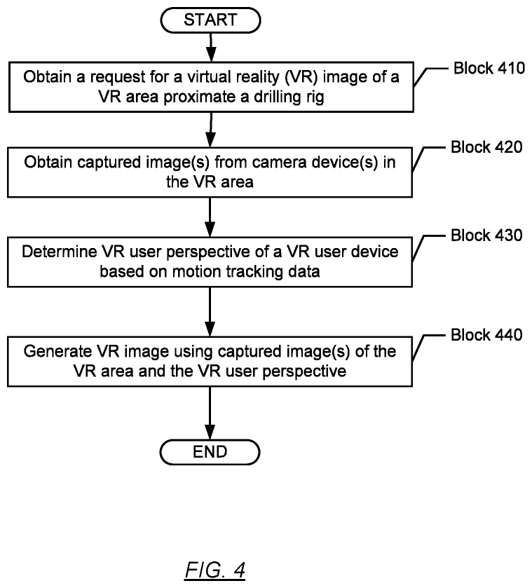

Turning to FIG. 4, FIG. 4 shows a flowchart in accordance with one or more embodiments. Specifically, FIG. 4 describes a method for generating VR images of a VR area. One or more blocks in FIG. 4 may be performed by one or more components as described above in FIGS. 1-3 (e.g., VR manager (350)). While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 410, a request is obtained for a VR image of a VR area proximate a drilling rig in accordance to one or more embodiments. The request may be an event triggering obtaining the VR image. The request may be triggered by one user action (i.e., such as pressing a button on a VR user device) or by a sequence of steps followed in a GUI. As such, a VR user device may be a VR headset that selects a VR area from an interface upon triggering of the obtaining request.

In Block 420, one or more captured images of the VR area are obtained from one or more camera devices in accordance to one or more embodiments. The VR manager may obtain captured images from the selected VR area and in response to the request. Further, a captured image may be a 360 degree image. In some embodiments, each captured image may be produced as a three-dimensional image, or live video feed, including depth perspective in any direction from a pivot point. Additionally, the captured images may be obtained through video feedback at a high refresh rate or the captured images may be obtained through a combination of fixed images, live video feed, or three-dimensional images.

In Block 430, motion tracking data is used to determine a VR user perspective for a VR user device in accordance to one or more embodiments. Motion tracking devices may be coupled to the VR manager for supplying the motion tracking data to the VR manager. For example, the VR manager may convert motion tracking data into location information and for generating a VR image. In one or more embodiments, location information includes parameters relating to the space and distances within an image. As such, based on the location information collected by the motion tracking devices, the VR image may be directly modified to show different perspectives from the various captured images. For example, the motion tracking devices may collect information that directly translates into movement for one or more camera devices in the VR area. In particular, a VR perspective may correspond to a portion of one or more captured images that are shown in a generated VR image.

In Block 440, a VR image is generated using one or more captured images of a VR area and the VR user perspective in accordance to one or more embodiments. Based on a VR user perspective, a VR image may be generated that matches the perspective of a user wearing a VR user device. In some embodiments, the VR images include various drilling equipment metadata, such as an identification of which VR area is the source of the VR image, which drilling equipment or drilling rig devices are located in the VR area, etc.

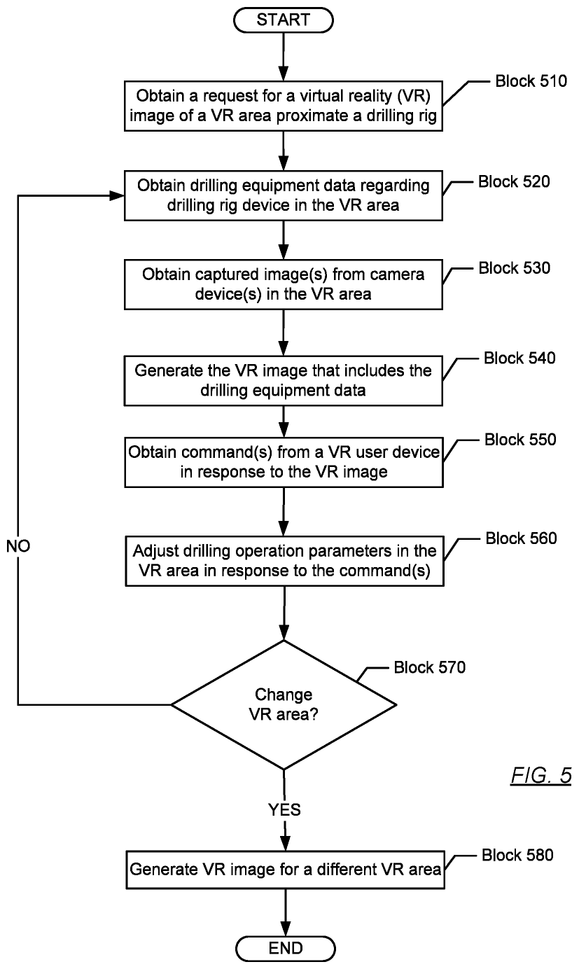

Turning to FIG. 5, FIG. 5 shows a flowchart in accordance with one or more embodiments. Specifically, FIG. 5 describes a method for using VR images of a VR area in combination with a VR manager. One or more blocks in FIG. 5 may be performed by one or more components as described above in FIGS. 1-3 (e.g., VR manager (350)). While the various blocks in FIG. 5 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 510, a request is obtained for a VR image of a VR area located in proximity a drilling rig in accordance to one or more embodiments. For example, this step may be similar to Block 410 described above.

In Block 520, drilling equipment data is obtained regarding a drilling rig device in a VR area in accordance to one or more embodiments. For example, drilling equipment data may be broadcasted from the drilling equipment or collected by one or more sensors adjacent to the drilling equipment. In addition, the drilling equipment data is transferred through a coupling of the drilling rig device with a VR manager.

In Block 530, one or more captured images of the VR area are obtained from one or more captured devices in accordance to one or more embodiments. For example, this step may be similar to Block 410 described above.

In Block 540, the VR image is generated that includes drilling equipment data in accordance to one or more embodiments. In particular, a VR image is generated that includes pre-selected including drilling equipment data. The drilling rig data may include information relating to heat parameters, electro-magnetic parameters, or safety parameters necessary, or important, for operating the rig site.

In one embodiment, for example, the drilling equipment data is VR image metadata of a drilling rig. The VR image metadata may be a combination of two or more information parameters corresponding to physical attributes of the point of interest. These attributes may be attributes presented in real time (e.g., currently happening or present at the point of interest) or presented by way of prediction (e.g., will happen in the future based on determined trends). In particular, in one or more embodiments, data relating to the point of interest is drillstring data of a drilling rig. The drillstring data may be introduced as an overlay of the drillstring captured image. Furthermore, data relating to attributes relating to the point of interest drilling site data of the drillstring captured image data relating to the point of interest is drillstring attributes. The drillstring data and the drillstring attributes may be physical attributes denoted with a corresponding color overlay and they may be replaces based on preset parameters or a selection implemented by a VR manager or a VR user device.

In Block 550, one or more commands are obtained from a VR user device in response to a VR image in accordance to one or more embodiments. In particular, an input may be obtained from a user using a VR user device, and that the input triggers a command by the VR manager. For example, the command may be specific to drilling equipment within a VR area being viewed by the user. To this point, the VR manager may rely on commands obtained from a VR user device to instruct operations of the drilling rig. Since the drilling site is monitored and operations may be managed remotely by the VR manager, the drilling site responds directly to the commands instructed.

In Block 560, drilling operation parameters are adjusted in a VR area in response to the one or more commands in accordance to one or more embodiments. In such event, the commands are transmitted from the VR user device to the drilling rig site. That is, commands may go to the VR manager, which then translates the command for adjusting the drilling operation parameters at a drilling rig device.

In addition, a VR user device may configure windows or view ports that show up in a current view of the VR image. In particular, these windows may display a live view from a section of a different 360 degree camera (e.g., a simulated CCTV view), the entire live view from an traditional CCTV camera, or an information display readout. Furthermore, placing a person in a green room with a standard control chair allows for the use of mixed reality that may be based on control system data. Likewise, a VR manager may dynamically filter out the green areas of the green room and replace the green areas with actual views of operating drilling rig equipment. This may give the effect of transporting a user in the control chair to anywhere those camera devices are located around a drilling rig. Mixed reality glasses (e.g. Microsoft HoloLens) could also be used to similar effect. These two considerations combined may provide a control cabin which looks and feels to a person much like control cabins disposed onsite. Likewise, the augmented control cabin may provide a user with the added benefits of safety and ideal line of sight of drilling rig devices in a VR area since it may be easier to place a relatively small camera in an area of a drilling rig, compared to a whole driller's cabin.

In Block 570, a determination is made as to whether a VR area is changed in accordance to one or more embodiments. For example, a user may decide to observe a different area at a drilling rig site, and enter an input using a VR user device to obtain a VR image of a different location. If it is determined that the VR area is to not be changed, the method proceeds to Block 520 to obtain drilling equipment data regarding the drilling site in the current VR area. For example, a VR user device may change the current VR area to a different VR area upon signaling of an event occurring in the different VR area. As such, the change to different VR area may be directed by a sensor or a peripheral coupled to the drilling rig site.

Further, receiving a request causes the VR manager to determine that a different VR area is desired for the user. In such event, a selection for changing to a different VR area has been selected to incorporate parameters from a VR area that is other than the current VR area. As such, a decision is made to decide whether a the current VR area must be replaced with the different VR area. For example, the VR user device changes the current VR area to a different VR area upon signaling of an event occurring in the different VR area. In this case, the change to different VR area may be directed by a sensor or a peripheral coupled to the drilling rig site.

In Block 580, a VR image is generated using one or more captured images of a different VR area. The VR image is generated in a similar manner as the VR image generated for the VR area in Block 540.

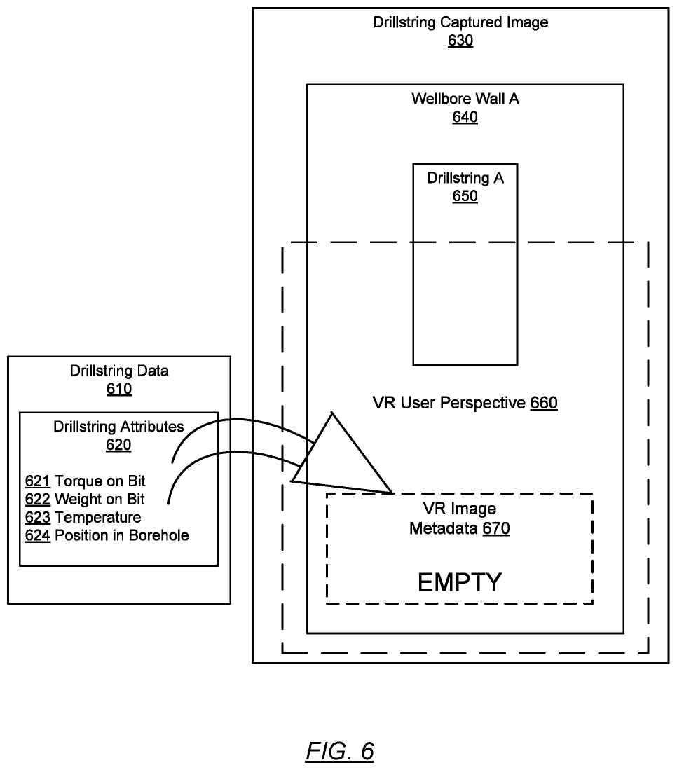

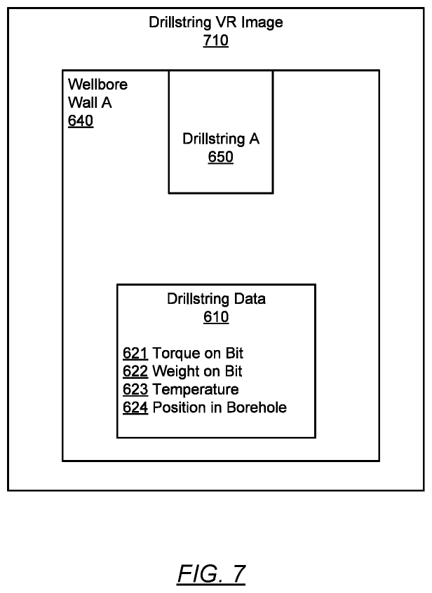

Turning to FIGS. 6 and 7, FIGS. 6 and 7 provide an example of generating a VR image in accordance with one or more embodiments. The following example is for explanatory purposes and not intended to limit the scope of the disclosed technology. Specifically, FIG. 6 illustrate a drillstring captured image (630) obtained of a drillstring A (650) that is disposed proximate a wellbore wall A (640). A VR manager (not shown) determines a VR user perspective (660) from a VR user device that requests a VR image of the drillstring A (650). The VR manager obtains drillstring data (610) that includes various drillstring attributes (620), such as the torque on bit (621), weight on bit (622), temperature (623), and a position (624) of the drillstring A (650) in a borehole. The VR manager then uses the drillstring data (610) as VR image metadata (670).

Turning to FIG. 7, FIG. 7 illustrates a drillstring VR image (710) generated by a VR manager using the VR user perspective (660), the drillstring captured image (630), and the drillstring data (610).

Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 8A, the computing system (800) may include one or more computer processor(s) (830), non-persistent storage (820) (e.g., random access memory (RAM), cache memory, flash memory, etc.), one or more persistent storage (840) (e.g., a hard disk, an optical drive such as a compact disk (CD) drive or digital versatile disk (DVD) drive, a flash memory stick, etc.), and numerous other elements and functionalities. The computer processor(s) (830) may be an integrated circuit for processing instructions. For example, the computer processor(s) may be one or more cores, or micro-cores of a processor. The computing system (800) may also include one or more input device(s) (860), such as a touchscreen, keyboard, mouse, microphone, touchpad, electronic pen, or any other type of input device. Further, the computing system (800) may include one or more output device(s) (810), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (800) may be connected to a network system (805) (e.g., a local area network (LAN), a wide area network (WAN) such as the Internet, mobile network, or any other type of network) via a network interface connection (not shown). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (800) may be located at a remote location and be connected to the other elements over a network system (805). Further, one or more embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

The computing system (800) in FIG. 8A may be connected to or be a part of a network. For example, as shown in FIG. 8B, the network system (805) may include multiple nodes (e.g., node X (816), node Y (817)). Each node may correspond to a computing system, such as the computing system shown in FIG. 8A, or a group of nodes combined may correspond to the computing system shown in FIG. 8A. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (815) may be located at a remote location and connected to the other elements over a network.

Although not shown in FIG. 8B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (816), node Y (817)) in the network (815) may be configured to provide services for a client device (825). For example, the nodes may be part of a cloud computing system. The nodes may include functionality to receive requests from the client device (825) and transmit responses to the client device (825). The client device (825) may be a computing system, such as the computing system shown in FIG. 8A. Further, the client device (825) may include and/or perform all or a portion of one or more embodiments of the disclosure.

The computing system or group of computing systems described in FIGS. 8A and 8B may include functionality to perform a variety of operations disclosed herein. For example, the computing system(s) may perform communication between processes on the same or different systems. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until the server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system (800) in FIG. 8A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 8A, while performing one or more embodiments of the disclosure, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B includes comparing the first element of vector A with the first element of vector B, the second element of vector A with the second element of vector B, etc. In one or more embodiments, if A and B are strings, the binary values of the strings may be compared.

The computing system in FIG. 8A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 8A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 8A and the nodes and/or client device in FIG. 8B. Other functions may be performed using one or more embodiments of the disclosure.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method, comprising:
obtaining, by a virtual reality (VR) manager, a request for a VR image of a first VR area among a plurality of VR areas proximate a drilling rig, wherein the first VR area is associated with at least one drilling rig device;
obtaining, by the VR manager, a captured image from a camera device disposed in the first VR area;
determining, by the VR manager, a VR user perspective based on motion tracking data of a VR user device; and
generating, by the VR manager and using the captured image, a VR image from the VR user perspective.

2. The method of claim 1, further comprising:
obtaining, by the VR manager, drilling equipment data regarding the at least one drilling rig device in the first VR area; and
displaying the VR image, wherein the VR image comprises the drilling equipment data.

3. The method of claim 1, further comprising:
obtaining, by the VR manager, a command from the VR user device; and
adjusting, by the VR manager, a plurality of drilling operation parameters of the at least one drilling rig device located within the first VR area in response to the command

4. The method of claim 3,
wherein adjusting the plurality of drilling operation parameters comprises:
actuating a programmable logic controller (PLC); and
adjusting, by the PLC, the drilling operation parameters of the drilling rig device.

5. The method of claim 1, further comprising:
obtaining, by the VR manager, a request from the VR user device for a second VR area different from the first VR area; and
generating, by the VR manager, a VR image for the second VR area.

6. The method of claim 2, further comprising:
obtaining, by the VR manager, updated drilling equipment data regarding the at least one drilling rig device.

7. The method of claim 1,
wherein the at least one drilling rig device is a mud pump, draw works, or a drill string.

8. The method of claim 1,
wherein the VR manager provides a plurality of VR images illustrating a simulation of a location or a size of the at least one drilling rig device in the first VR area using a simulator coupled to a control system,
wherein the plurality of VR images are provided in at least one green area of a control cabin, and
wherein the location or the size of the at least one drilling device is adjusted in response to the at least one simulation.

9. The method of claim 1,
wherein the VR manager is located at a remote location from the drilling rig,
wherein the VR manager generates a VR control cabin for the drilling rig, and
wherein the VR control cabin is substantially similar to a control cabin physically located at the drilling rig.

10. A system, comprising:
a drilling rig device and a camera device disposed in a first virtual reality (VR) area proximate a drilling rig;
a VR user device disposed outside the first VR area;
a VR manager comprising a processor and coupled to the VR user device and the camera device over a drilling management network,
wherein the VR manager obtains a captured image from the camera device, and
wherein the VR manager generates a first VR image using a portion of the captured image and a VR user perspective based on motion tracking data of the VR user device.

11. The system of claim 10, further comprising:
wherein the VR manager obtains drilling equipment data regarding the drilling rig device, and
wherein the VR image is generated with the drilling equipment data.

12. The system of claim 10,
wherein the VR manager obtains a plurality of commands from a VR user device, and
wherein the drilling rig device adjusts drilling operation parameters in the VR area in response to the plurality of commands.

13. The system of claim 12,
wherein adjusting the drilling operation parameters comprises:
actuating a plurality of robotic elements coupled to the camera device; and
interacting with the drilling rig device, by the plurality of robotic elements, to adjust the drilling operation parameters.

14. The system of claim 10,
wherein the VR manager obtains a request for an image of a different VR area, and
wherein the VR manager generates the second VR image for the different VR area.

15. The system of claim 10, wherein the drilling rig device is a mud pump, draw works, or a drill string.

16. The system of claim 10,
wherein the camera device is a 360 degree camera.

17. The system of claim 10, further comprising:
a control system; and
a simulator coupled to the control system and the VR Manager,
wherein the simulator generates a simulation of the first VR area and the second VR area, and
wherein the VR manager generates a plurality of VR images for a user providing a visual experience of the simulation.

18. A non-transitory computer readable medium storing instructions executable by a computer processor, the instructions comprising functionality for:
obtaining, by a virtual reality (VR) manager, a request for a VR image of a first VR area among a plurality of VR areas proximate a drilling rig, wherein the first VR area is associated with a drilling rig device;
obtaining, by the VR manager, a captured image from a camera device disposed in the first VR area;
determining, by the VR manager, a VR user perspective based on motion tracking data of a VR user device; and
generating, by the VR manager and using the captured image, a VR image from the VR user perspective.

19. The non-transitory computer readable medium of claim 18, the instructions further comprising functionality for:
obtaining, by the VR manager, drilling equipment data regarding the drilling rig device in the first VR area; and
displaying the VR image, wherein the VR image comprises the drilling equipment data.

20. The non-transitory computer readable medium of claim 18, the instruction further comprising functionality for:
obtaining, by the VR manager, a command from the VR user device; and
adjusting, by the VR manager, a plurality of drilling operation parameters of the drilling rig device located within the first VR area in response to the command
